(19) United States
(12) Patent Application Publication
(10) Pub. No.: US 2026/0228726 A1
(43) Pub. Date: Aug. 6, 2026

(54) ENHANCED GUEST CHECKOUT TOKENIZATION

(71) Applicant: MASTERCARD ASIA/PACIFIC PTE. LTD., Singapore (SG)

(72) Inventors: Abhinava SRIVASTAVA, Singapore (SG); MohamedRafiq RAKHDA, London (GB)

(21) Appl. No.: 19/043,122

(22) Filed: Jan. 31, 2025

(51) Int. Cl. G06Q 20/40; G06Q 20/38; H04L 9/08

(52) U.S. Cl. CPC G06Q 20/401; G06Q 20/382; H04L 9/0863

(57) ABSTRACT

Verifying payment card transactions includes generating a cryptogram as a transaction key presentable to a payment network during authorization; storing a cryptogram mapping record that includes at least the cryptogram and a token associated with a payment card; receiving a cryptogram verification request message from the payment network during authorization of a payment card transaction, the cryptogram verification request message including the token and the cryptogram; identifying the cryptogram mapping based on the cryptogram presented in the cryptogram verification request message; comparing the token from the cryptogram verification request message to the token from the cryptogram mapping record to determine a match; and in response to the comparing, transmitting a cryptogram verification success message to the payment network, thereby causing the payment network to send the authorization request to an issuer.

### BACKGROUND

The handling of payment card transaction data is typically done via a process called “tokenization.” When a customer initiates a transaction with a merchant, the payment card details of the customer (e.g., the primary account number (PAN) of the payment card) are securely sent from the merchant to a tokenization service via encrypted communications. The tokenization service generates a unique token for that payment card number and stores a mapping of that token to the underlying payment card and its associated details. This token is typically a randomly generated string of characters that has no intrinsic value and cannot be reverse-engineered to retrieve the original card information (without access to the mapping details).

After creation, the token is returned to the merchant and is subsequently used in lieu of the PAN when performing the transaction. During transaction authorization, in some conventional systems, the tokenization service converts (e.g., unmaps) the token back into the original PAN before sending the transaction details (including the PAN of the payment card) to the issuer for authorization. The issuer then verifies the PAN and either approves or denies the transaction. In addition to facilitating the initial transaction, the token can also be stored by the merchant for use by the customer in future transactions, thereby avoiding the merchant having to store the original payment card data of the customer and the security concerns and exposures that occur with such retentions.

### SUMMARY

Some examples provide an enhanced tokenization system comprising: at least one processor; and at least one memory comprising computer-readable instructions, the at least one processor, the at least one memory and the computer-readable instructions configured to cause the at least one processor to: receive a first request from a merchant device, the first request including a primary account number (PAN); generate a token, the token being usable as a substitute for the PAN in a payment network; generate a cryptogram, the cryptogram being a single-use transaction key for a transaction on the payment network; store a cryptogram mapping between the token and the cryptogram; transmit the token and the cryptogram to the merchant device in response to the first request; receive a cryptogram verification request message from the payment network, the cryptogram verification request message being associated with an authorization request of the payment network, the cryptogram verification request message including the token and the cryptogram; determine that the cryptogram and the token of the cryptogram verification request message are valid based on the token and the cryptogram appearing in the cryptogram mapping; and respond to the cryptogram verification request message with a success indicator, thereby causing the payment network to send the authorization request to an issuer.

Some examples provide a computer-implemented method comprising: receiving a first request message from a merchant device, the first request including a payment card identifier associated with a payment card; generating a cryptogram, the cryptogram being a transaction key presentable to a payment network during authorization of payment card transactions; storing a cryptogram mapping record that includes at least the cryptogram and a token associated with the payment card identifier; receiving a cryptogram verification request message from the payment network, the cryptogram verification request message being associated with an authorization request presented to the payment network, the cryptogram verification request message including the token and the cryptogram; identifying the cryptogram mapping based on the cryptogram presented in the cryptogram verification request message; comparing the token from the cryptogram verification request message to the token from the cryptogram mapping record to determine a match; and in response to the comparing, transmitting a cryptogram verification success message to the payment network, thereby causing the payment network to send the authorization request to an issuer.

Some examples provide a computer storage medium having computer-executable instructions that, upon execution by a processor of a computer, cause the processor to at least: receive, from a merchant computing device, a first request message that includes a primary account number (PAN) of a payment card and an original transaction amount; generate an original token, the original token being usable as a substitute for the PAN in a payment network; generate an original cryptogram; store a cryptogram mapping between the original token, the original cryptogram, and the original transaction amount; transmit the original token and the original cryptogram to the merchant computing device in response to the first request message; receive a cryptogram verification request message from the payment network, the cryptogram verification request message being associated with a transaction authorization request, the cryptogram verification request message including a presented token, a presented cryptogram, and a presented transaction amount; determine that the original cryptogram matches the presented cryptogram, and the original token matches the presented token based on the cryptogram mapping; and respond to the cryptogram verification request message with a success indicator, thereby causing the payment network to send the authorization request to an issuing bank for authorization.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an architecture diagram of an example enhanced tokenization (ET) system that is configured to implement cryptograms in payment card transactions for secure transaction verification;

FIG. 2 is a sequence diagram illustrating an example flow of operations performed by participants of an ET system (such as the ET system of FIG. 1) during the preparation phase of a particular transaction;

FIG. 3 is a sequence diagram illustrating an example flow of operations performed by participants of an ET system (such as the ET system of FIG. 1) during the transaction authorization phase of a particular transaction;

FIG. 4 is a flow chart of an example process for securing payment card transactions with cryptograms; and

FIG. 5 is a functional block diagram of a computing apparatus according to an embodiment.

Corresponding reference characters indicate corresponding parts throughout the drawings. Any of the figures may be combined into a single example or embodiment.

### DETAILED DESCRIPTION

Conventional tokenization, by itself, adds a layer of security by substituting the payment card information (e.g., the primary account number (PAN)) with a nonce identifier that can be easily replaced. However, even with this extra protection, such conventional tokenization does not remediate all security concerns. For example, the tokens could be intercepted and utilized for fraudulent transactions, especially if the token is not bound to a specific merchant. Additionally, the storage of the tokens by the merchants may be insecure and potentially vulnerable.

In contrast, an example enhanced tokenization (ET) service and associated systems and methods are described herein. The ET service improves tokenization of payment credential information by creating a unique cryptogram for each transaction. A cryptogram is a nonce data element (e.g., a randomly generated string of data, or the like) that is shared with a merchant during a preliminary stage of a consumer transaction. Prior to the transaction authentication and authorization process that happens during a cardholder transaction, the merchant initiates certain tokenization steps using the payment card information provided by the cardholder, as well as transaction data specific to the merchant and that particular transaction. More specifically, if the merchant does not already have a token on file for the PAN provided by that cardholder, the merchant submits a tokenization request to the ET service (e.g., thereby mapping the PAN of the consumer to a particular token that can be used in lieu of PAN during later transaction authentication and authorization). The ET service securely stores and maintains a mapping of this token to the original PAN of the cardholder for later use.

In addition to the tokenization of the PAN, in examples, the merchant also submits a request for a cryptogram for this particular transaction. This request includes the token of the cardholder, a merchant ID of the requesting merchant, and a transaction amount for this transaction. The ET service generates a new cryptogram and shares this cryptogram with the merchant. In addition, the ET service stores a mapping of the cryptogram to the particular token, as well as additional transaction details including, for example, a merchant ID of the requesting merchant and a transaction amount of this particular transaction. Such details are later used to verify the transaction, as described below.

After receiving the cryptogram for this particular transaction, the merchant submits a transaction request to a payment network via their acquiring bank and/or a payment gateway. In addition to typical transaction details such as a merchant identifier and a transaction amount (as well as potentially other transaction-level details), this transaction request also includes the token (e.g., in lieu of the PAN), thereby protecting the PAN of the user during certain steps of this transaction. Further, the transaction request also includes the cryptogram generated for this particular transaction, as provided by the ET service.

During transaction authorization, the acquirer (or payment gateway) submits a transaction authorization request for this transaction to the payment network. This authorization request includes the token, the cryptogram, the merchant ID, and the amount of the transaction, as well as perhaps other transaction details. Before sending this authorization request on to the issuer, the payment network utilizes the ET service to perform two primary steps: (1) converting the token back into the associated PAN of the consumer (a step referred to herein as “detokenization”); and (2) using the cryptogram and associated details to perform an additional transaction verification (a step referred to herein as “cryptogram verification”).

Detokenization involves the ET service using the token to “unmap” the token, converting the token back into the PAN of the consumer's underlying payment card account. As such, the PAN can be used when subsequently authorizing this transaction with the issuing bank associated with the payment card.

Cryptogram verification, in the example, is an extra verification step performed during transaction authentication, where details of this submitted transaction are compared against the transaction details identified during the earlier tokenization stage (e.g., when the cryptogram was requested). More specifically, when the payment network receives the authorization request for a given transaction, the ET service searches a mapping database to identify whether there is a record matching both the token and the cryptogram provided in the authorization request. If no matching record is found, then one of the token or the cryptogram are invalid and the transaction is declined. If a matching record is found, then certain transaction details from the authorization request are compared against such details stored in the matching record of the ET service. For example, if the merchant ID from the authorization request does not match the merchant ID of the merchant who requested the cryptogram, the transaction is declined. If the transaction amount from the authorization request does not match (or is not within a threshold range of) the transaction amount provided during the cryptogram request, then the transaction is declined. If all such “verification data” matches with the data in the authentication request, then the ET service certifies the cryptogram verification portion of this transaction with the payment network and the payment network then forwards the authorization request on to the issuing bank, substituting the PAN for the token. Accordingly, the issuing bank either approves or declines this particular transaction.

The terms “token”, “PAN” or “FPAN” (Full PAN), and “payment card” or “payment card account” may be used interchangeably herein, inasmuch as each token maps to a particular PAN, and each PAN is representative of a particular payment card or a payment card account. Depending on the stage of a given transaction, the payment card of the cardholder may be represented by the PAN (e.g., before tokenization mapping, after tokenization unmapping) or by a token (e.g., after tokenization mapping, during certain stages of tokenization and transaction processing). As such, the terms payment card and payment card account may be used to refer, generically, to the consumer account, even though the account number in use at various stages of the transaction may be in the form of the PAN or the token substituting for the PAN.

The example systems and methods described herein provide various technical improvements over conventional systems. The generation and use of cryptograms as transaction keys presentable during authorization of payment card transactions causes a reduction in network traffic on the payment network, as well as a reduction of computer processing, at least in that verification of the cryptograms during authentication allows the payment network to avoid additional processing associated with fraudulent transactions. More specifically, many fraudulent transactions can be declined by this system via a comparison of the token from the cryptogram verification request message to the token from the cryptogram mapping record to determine a match. If such fraudulent transactions are not caught by this system prior to applying other known fraud detection systems, such as risk scoring and the like, then such more computationally-complex conventional risk scoring systems will be applied to the transactions, thereby causing additional computational burden during later stages of transaction authorization (e.g., on the payment network, on the issuers). As such, the systems and methods described herein are able to capture and decline some types of fraudulent transactions, thereby avoiding the more computationally burdensome techniques of risk scoring (and hence reducing consumption of computing resources and improving the functioning of the computing devices executing such techniques).

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

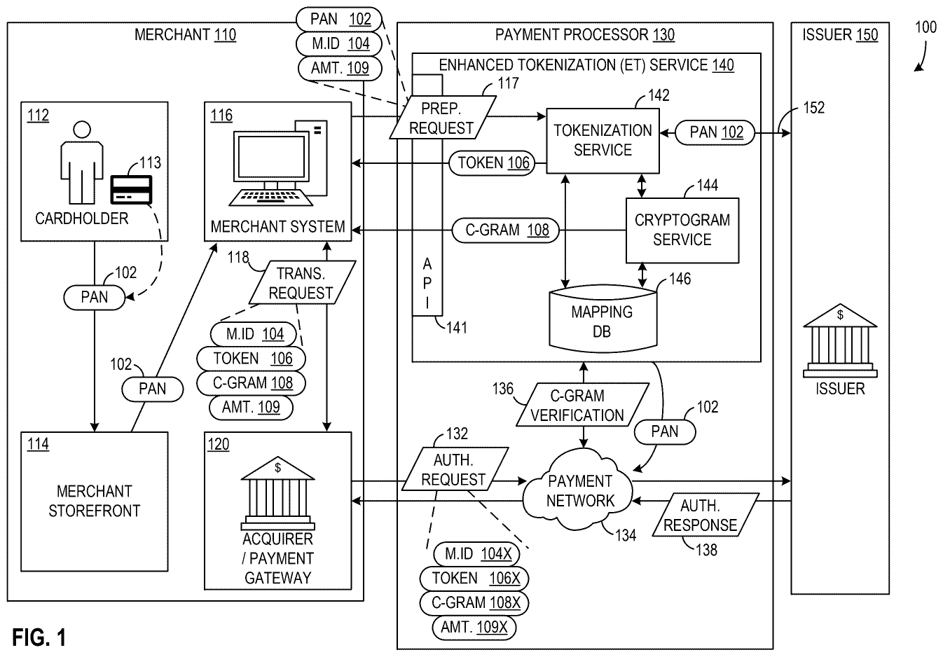

FIG. 1 is an architecture diagram of an example enhanced tokenization (ET) system 100 that is configured to implement cryptograms in payment card transactions for secure transaction verification. In the example, various tokenization and cryptogram functions are provided by an ET service 140. The ET service 140 allows merchants 110 to perform transactions with the added security layer that includes both tokenization of payment card data (e.g., via tokens 106 provided by a tokenization service 142) as well as cryptograms (e.g., “c-grams” 108 provided by a cryptogram service 144). Tokenization of payment card data adds security to payment card transactions by, for example, replacing a primary account number (PAN) 102 of a cardholder 112 (and perhaps other payment card data, such as expiry, security code, or the like) with a uniquely-created substitute for that payment card (e.g., the token 106, a randomly generated string of characters, the mapping of which is securely stored during “detokenization”). The cryptogram 108 is a nonce data element that is created by the ET service 140 for each transaction during a preparation stage. In examples, the cryptogram 108 is bound to a particular token (e.g., the payment card of the transacting cardholder), to a particular merchant (e.g., the merchant requesting the cryptogram), and to transaction details for a particular transaction (e.g., a specific transaction amount). This cryptogram 108 is shared with the requesting merchant 110 for use during the transaction.

During a payment authorization stage, the token and cryptogram are submitted to a payment network 134 when requesting authorization for the payment card transaction. The payment network 134 uses the ET service 140 to compare the transaction details submitted for authorization with the original details bound to the cryptogram. If the token or the merchant or the payment amount do not match the details bound to the cryptogram during the preparation stage, then the transaction is declined (e.g., prior to proceeding to an issuing bank). Accordingly, such use of the cryptogram 108 adds an additional layer of security. The generation and use of cryptograms 108 are discussed in greater detail below.

Consider an example payment card transaction performed by the cardholder 112 at the merchant 110, as shown in FIG. 1. In this example, the cardholder 112 is shopping at a merchant storefront 114, such as in person (e.g., at a brick-and-mortar retail location) or via an online venue (e.g., an e-commerce site, or the like). At time of purchase, the cardholder 112 provides a PAN 102 of their payment card 113 (e.g., via a swipe, chip scan or insert at a point-of-sale device (not shown), via manually entering the PAN 102 and other payment card data (e.g., expiry, security code) into an online e-commerce site, or the like). As such, in this example, the PAN 102 (and perhaps other payment card data of the payment card) is received by a merchant system 116. It should be understood that other transaction data, cardholder data, and transaction processes may be performed during transactions enhanced by this ET system 100, and that some such steps or data may be excluded from these examples for clarity of description where those steps or data are not particularly meaningful to the tokenization and cryptogram features central to this disclosure. Any such data and steps needed to practice the systems and methods described herein are within scope of this disclosure.

During a preparation stage, the ET service 140 receives transaction details from the merchant system 116 for this specific transaction with the cardholder 112. More specifically, in examples, the merchant system 116 securely transmits a preparation request message (or just “prep request”) 117 to the ET service 140 (e.g., as an encrypted message sent via application programming interface (API) 141). The prep request 117 includes the PAN 102 of the payment card 113 of the cardholder 112 (and perhaps other payment card data, such as expiry, security code, or the like, not separately shown), a merchant identifier for the merchant 110 (e.g., a merchant identification number (MID), a digital payment identifier (DPID), or the like, shown here as “M. ID” 104), and the payment amount of the pending transaction (e.g., shown here as “amt” 109). In this example, this prep request 117 represents a combined request to both tokenize the PAN 102 associated with this transaction as well as to generate a cryptogram (or just “c-gram”) 108 for this transaction.

In this example, the ET service 140 includes a tokenization service 142 that is configured to respond to such requests. Here, the tokenization service 142 verifies the PAN 102 with the issuer 150 before generating a new token 106 for this PAN 102. More specifically, the tokenization service 142 securely transmits a validation request 152 to the issuer 150, including the PAN 102, thereby allowing the issuer 150 to, for example, validate that the PAN 102 is active, and that the issuer 150 approves the tokenization for this PAN. In other examples, this validation request 152 may be skipped (e.g., in situations where the issuer 150 does not elect to validate tokenization of PANs 102).

After validation, in the example, the tokenization service 142 generates the token 106 that will be used to represent the PAN 102. In some examples, this token 106 is a randomly generated string of numeric or alpha-numeric characters with no mathematical relationship to the underlying PAN 102. In some examples, the tokenization service 142 ensures that the token 106 is unique (e.g., amongst other tokens generated by the ET service 140). In some examples, the token 106 is created with 16 digits (e.g., to resemble the format of a typical PAN). In the example, the token 106 is a multi-use, merchant-independent token (e.g., a “persistent” token 106 is usable in multiple transactions, and a merchant-independent token 106 may be used at other merchants than just the requesting merchant 110). In other examples, the token 106 may be a single-use token (e.g., expiring after a single transaction attempt or a single successful transaction using that token). In some examples, the token 106 may be a merchant-specific token (e.g., only valid for use in transactions involving a specific merchant, such as the requesting merchant 110).

In the example, upon creation of this token 106, the tokenization service 142 stores a record of this token 106 and the associated PAN 102 (as well as potentially other payment card data such as the expiry, security code, or the like), thereby facilitating detokenization at a later time, where the token 106 will be converted back into the associated PAN 102. In the example, these token mapping records are stored in a mapping database (DB) 146. These mappings are referred to herein as “tokenization mappings,” as they allow the PAN 102 to be mapped to the token 106 (e.g., during “tokenization”), and vice versa (e.g., during “detokenization”). The newly generated token 106 is sent back to the merchant system 116 (e.g., in response to the prep request 117).

Additionally, in the example, processing of the prep request 117 also causes a cryptogram service 144 to generate a cryptogram 108 for this specific transaction. In examples, the cryptogram 108 is nonce data, randomly generated as a string of alpha-numeric characters of a fixed size (e.g., 32 characters, 64 characters, 128 characters, or the like). Further, in some examples, the cryptogram service 144 ensures that the cryptogram 108 is unique (e.g., relative to other cryptograms created by the cryptogram service), regenerating a new cryptogram 108 if a duplicate is produced.

The cryptogram 108 is bound to aspects of a specific transaction. More specifically, in the example, the newly generated cryptogram 108 is bound to the token 106 identified in the prep request 117 (and thus the payment card 113 of the cardholder 112), as well as the requesting merchant 110 (e.g., identified by M. ID 104) and the transaction amount for this transaction (e.g., identified by amt 109). This “binding”, in examples, is represented by storing a record in the mapping DB 146 that includes at least the token 106, the cryptogram 108, the merchant ID 104, and the amt 109. In some examples, other data may be stored with this record, such as other transaction data, issuer data, merchant data and, later, use data indicating whether, when and how the cryptogram has been used. This record for the cryptogram 108 thus represents a mapping between a specific cryptogram 108 and a token 106, as well as perhaps a merchant ID 104 and a transaction amount 109. These records are referred to herein as “cryptogram mappings,” as they allow a particular cryptogram 108 to be associated with (e.g., mapped to) a particular token 106 and perhaps a particular merchant ID 104 and transaction amount 109. The newly generated cryptogram 108 is also sent back to the merchant system 116 (e.g., in response to the prep request 117, as a separate message, or the like).

After the merchant system 116 has successfully tokenized the PAN 102 of the cardholder 112 and received a cryptogram 108 specific to this transaction, the merchant system 116 is then able to send a transaction request 118 to their acquirer 120 or payment processor. In the example, this transaction request 118 contains the transaction amount 109, the cryptogram 108, the token 106, and the merchant ID 104 (as well as perhaps other relevant transaction information). In response, the acquirer 120 initiates an authentication request (not separately shown) and an authorization request 132 through the payment network 134. The authentication request portion of this transaction processing is omitted here, as it is not particularly pertinent to use of the cryptograms 108. As such, it is presumed that the cardholder 112 is successfully authenticated with the payment network 134, thereby allowing the authorization request 132 to proceed.

In the example, the authorization request 132 includes a token 106X, a cryptogram 108X, a merchant ID 104X, a transaction amount 109X, and perhaps other transaction data typically included during transaction authorization. These elements 106X, 108X, 104X, 109X include an “X” suffix to distinguish their values in the authorization request 132 from their counterparts (as they appeared during the preparation process), namely token 106, cryptogram 108, merchant ID 104, and transaction amount 109. It should be understood that any of the values of elements 106X, 108X, 104X, and 109X may be different than their counterpart elements 106, 108, 104, and 109, and it is a feature of the systems and methods described herein to identify these discrepancies.

Upon receipt of the authorization request 132, the payment network 134 performs both detokenization of the token 106X as well as verification of the cryptogram 108X. These processes are shown collectively, in FIG. 1, as cryptogram verification message 136. In some examples, the payment network 134 diverts authorization requests 132 having certain bank identification number (BIN) ranges to the ET service 140 for detokenization and/or cryptogram verification. In some examples, the payment network 134 diverts authorization requests 132 to ET service 140 for detokenization and/or cryptogram verification whenever the authorization request 132 includes a tokenized credential (e.g., token 106) or a cryptogram 108. In examples, the payment network 134 transmits a cryptogram verification request message 136 to the ET service 140 to initiate these processes. The cryptogram verification message 136 includes the token 106X, the cryptogram 108X, the merchant ID 104X, and the transaction amount 109X. In response, the cryptogram service 144 performs cryptogram verification of the authorization request 132 based on the transaction details provided in the cryptogram verification message 136.

More specifically, in examples, the cryptogram service 144 searches the cryptogram mappings in the mapping DB 146 looking for a record that includes the cryptogram 108X and the token 106X. In situations where no record is found (e.g., if either the cryptogram 108X is not the cryptogram 108, or if the token 106X is not the token 106), then the cryptogram verification 136 is identified as unsuccessful. In situations where a record is found, then the cryptogram service 144 compares the merchant ID 104X from the authorization request 132 with the merchant ID 104 stored in the record. If the merchant IDs 104, 104X do not match, then the cryptogram verification 136 is identified as unsuccessful. Further, the cryptogram service 144 also compares the transaction amount 109X from the authorization request 132 with the transaction amount 109 stored in the cryptogram mapping. In some examples, if the transaction amounts 109, 109X are not an exact match, then the cryptogram verification 136 is identified as unsuccessful. In some examples, the transaction amount 109X is allowed to be within a range of the original transaction amount 109 before being identified as unsuccessful (e.g., within a predefined percentage of the original transaction amount 109, within a predefined amount above or below the original transaction amount 109, below a “not-to-exceed” value of the original transaction amount 109).

As such, the cryptogram service 144 validates whether or not the cryptogram 108X, token 106X, merchant ID 104X, and transaction amount 109X properly map to the cryptogram 108, token 106, merchant ID 104, and transaction amount 109 respectively stored in the mapping DB 146, thus resulting in either a success or a failure of the cryptogram verification 136. In situations where the cryptogram verification 136 is unsuccessful/failed, the ET service 140 responds to the payment network 134 with a failure message and the authorization request 132 is subsequently declined. In situations where the cryptogram verification 136 is successful, the ET service 140 responds to the payment network 134 with a success message. Further, in successful situations, the ET service 140 also performs detokenization of the token 106X (e.g., searching the tokenization mappings for the token 106X to identify the PAN 102 associated with that token 106. The ET service 140 thus also sends the PAN 102 to the payment network 134.

The cryptogram 108, in examples, is configured for single use. Once a single attempt to use the cryptogram 108 has succeeded or failed, in examples, the ET service 140 deactivates the cryptogram 108 (e.g., as a status update to a status flag for the entry for this cryptogram 108 in the mapping DB 146, deleting the entry for that cryptogram 108 in the DB 146, or the like). In other examples, the cryptogram 108 is configured to remain active until a successful transaction is performed using that cryptogram 108 (e.g., only updating or deleting the cryptogram 108 in the DB 146 after a successful cryptogram verification 136). In some examples, aspects of the authorization request 132 and/or the cryptogram verification 136 are stored by the ET service 140 (e.g., in the mapping DB 146), such as timestamp information for the cryptogram verification 136 (e.g., when the cryptogram verification 136 was received, performed, responded to, or the like), resulting status data associated with the cryptogram verification 136 (e.g., success/failure disposition, failure code(s)), transaction data associated with the authorization request 132 (e.g., merchant ID 104X, token 106X, transaction amount 109X, acquirer ID or payment gateway ID, or any such transaction data).

In examples, when the cryptogram verification 136 is successful, the payment network 134 continues on with the authorization request 132, transmitting an authorization request message (not separately shown) to the issuing bank associated with the PAN 102 (e.g., issuer 150), replacing the token 106X with the PAN 102 provided by the ET service 140. Accordingly, the issuer 150 either approves or declines this authorization request message 132 (e.g., for typical reasons such as insufficient funds, credit limit exceeded, suspected fraud, account status issues, or the like), prompting an authorization response message (or just “authorization response”) 138 to be sent back to the payment network 134, on to the acquirer 120 or payment gateway, and all the way to the merchant system 116 and/or the cardholder 112. As this authorization response 138 is passing through the payment network 134, in some examples, the payment network 134 replaces the PAN 102 with the token 106X, thereby continuing to mask the PAN 102 with the acquirer 120 through this last stage of the transaction.

As such, inclusion of the cryptogram 108 with the transaction request 118 and authorization request 132 thus allows the ET system 100 to perform additional verification of authorization requests 132 during transaction authorization, verifying that certain details of the authorization request 132 (e.g., token 106X, merchant ID 104X, transaction amount 109X) comply with certain expectations (e.g., matching the token 106, merchant ID 104, and matching or within a range of transaction amount 109 established during the preparation stage). If, for example, the token 106 and cryptogram 108 is used for a second transaction (e.g., after already being used for another), the cryptogram verification 136 will fail due to inactivity or deletion of the original entry for that cryptogram 108 in the mapping DB 146. If the token 106 and cryptogram 108 is used for a transaction amount that does not match, or is not within an allowed range of, the original transaction amount identified during the preparation stage (e.g., if the merchant system 116 or acquirer 120 erroneously or surreptitiously alters the transaction amount 109X, then that cryptogram verification 136 will fail due to this mismatch. If the token 106 is compromised and used by a nefarious third party, the lack of a cryptogram 108 will cause the cryptogram verification 136 to fail. If both the token 106 and the cryptogram 108 are compromised, the mismatch between the original merchant ID 104 and the ID of the third party will cause the cryptogram verification 136 to fail. As such, the cryptogram verification 136 adds numerous aspects of security protection to the authorization process.

During the preparation stage, many of the above examples show the ET service 140 generating both the token 106 and the cryptogram 108 in response to a single request (e.g., the prep request 117). In some situations, the merchant system 116 may have already tokenized the PAN 102 of the cardholder 112. For example, after the example transaction and its associated prep request 117, the merchant system 116 may store the token 106 and allow the cardholder 112 to perform later transactions with that same token 106 (e.g., in a “card-on-file” or “stored credentials” scenario, thereby allowing the cardholder 112 to proceed without reentering their payment card information). During a subsequent transaction, the merchant system 116 identifies that the cardholder 112 already has the token 106 stored with the merchant system 116, and thus can skip tokenization. Accordingly, in examples, the ET service 140 also supports a cryptogram request (not separately shown, but similar to prep request 117) to get just a cryptogram 108 for a particular transaction. Similar to the prep request 117, the cryptogram request includes the merchant ID 104 and the transaction amount 109, but accepts the pre-existing token 106 in lieu of the PAN 102. As such, the cryptogram service 144 similarly generates a new cryptogram 108 for the cryptogram request, likewise binding the new cryptogram 108 with the token 106, merchant ID 104, and transaction amount 109 in a new cryptogram mapping in the mapping DB 146. In some examples, the prep request 117 may be any of a tokenization-only request, a cryptogram-only request, or a combined tokenization+cryptogram request (e.g., like the example prep request 117 described above), and the ET service 140 may dynamically identify which type of request is presented based on the contents of the prep request 117. For example, if the prep request 117 does not include a transaction amount 109, then the ET service 140 treats this prep request 117 as a tokenization-only type request and only generates a new token 106 for the PAN 102 provided in the request. If the prep request 117 includes a token 106 and not a PAN 102 (e.g., determined by identifying a pre-existing tokenization mapping in the mapping DB 146 that includes the token 106), then the ET service 140 treats this prep request 117 as a cryptogram-only type request and only generates a new cryptogram 108. If the prep request 117 includes a PAN 102 (e.g., no token 106 found), and if the prep request 117 does include a transaction amount 109, then the ET service 140 treats this prep request 117 as a combined request, thereby generating both a token 106 and a cryptogram 108 for this request.

In some examples, the ET service 140 supports cryptograms 108 without tokenization. For example, instead of converting the PAN 102 into a token 106, the ET service 140 may be configured to use the PAN 102 when creating the cryptogram mapping in the mapping DB 146. Such a cryptogram mapping uses the PAN 102 in lieu of the token 106, for example binding the cryptogram 108 with the PAN 102, the merchant ID 104, and the transaction amount 109. In such scenarios, the transaction request 118 and the authorization request 132 include the PAN 102 rather than a token 106, and thus the cryptogram verification 136 also includes the PAN 102. Accordingly, the cryptogram verification process involves looking up the cryptogram 108 and verifying that the PAN from the authorization request 132 matches the PAN 102 stored in the cryptogram mapping.

In some examples, a transaction reference ID (TRID) is assigned for each transaction. For example, the payment processor 130 may generate a unique TRID for the transaction when the prep request 117 is received from the merchant system 116 (e.g., if the prep request 117 is not just a tokenization-only request, if the prep request 117 includes a transaction amount 109). Accordingly, the cryptogram mappings stored in the mapping DB 146 may additionally include the TRID of the transaction. In some examples, the TRID may be included in the transaction request 118 and the authorization request 132, and thus may be passed along with the cryptogram verification 136 and verified as an additional matching criterion for determining whether or not the transaction is verified or declined.

While many of the above examples bind a cryptogram 108 with a particular token 106, merchant ID 104, and transaction amount 109, it should be understood that other embodiments with more or less verification criteria are possible. For example, the ET service 140 may be configured to use just cryptogram 108 and token 106 when performing some cryptogram verifications 136. The ET service 140 may be configured to use cryptogram 108, token 106, and merchant ID 104 (e.g., without regard to a transaction amount). In some examples, the cryptogram verification process is configured to successfully verify only consumer-initiated transactions (CIT) and not merchant-initiated transactions (MIT). In such examples, the cryptogram verification 136 includes a transaction type indicator (e.g., a transaction category code, a recurring transaction indicator) that is used to determine if the transaction is a CIT or a MIT type transaction. In some examples, a successful cryptogram validation of a CIT transaction is used, during risk scoring of a subsequent MIT transaction authorization request, to generate an incrementally higher confidence score for that MIT transaction.

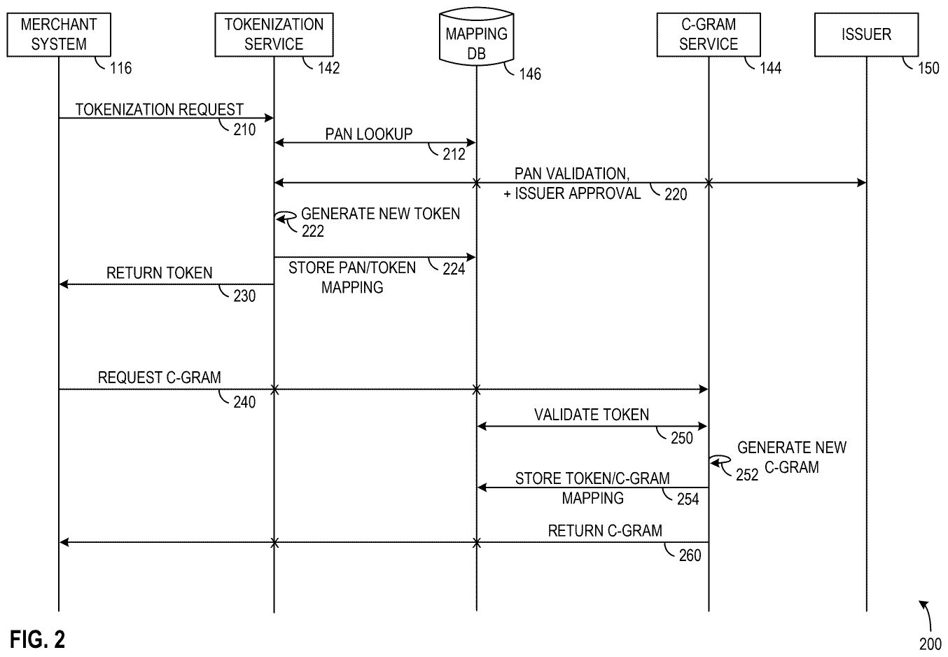

FIG. 2 is a sequence diagram 200 illustrating an example flow of operations performed by participants of an ET system (such as ET system 100 of FIG. 1) during the preparation phase of a particular transaction. In examples, the operations shown in FIG. 2 may be similar to those shown and discussed above in relation to FIG. 1. Further, for this example, it is presumed that the merchant system 116 has already interacted with the cardholder 112 to identify the PAN 102 to be used for this transaction, as well as the transaction amount 109 for this transaction. Additionally, while the tokenization service 142 and the cryptogram service 144 are separately identified in FIG. 2, it should be understood that these services 142, 144 are shown separately to group tokenization operations and cryptogram operations, but other architectures are possible. As such, the ET service 140 may be substituted for any of the tokenization service 142, the cryptogram service 144, and/or the mapping DB 146.

In the example shown in FIG. 2, operations 210-230 represent a tokenization process performed on a PAN 102 to generate and share a token 106. Operations 240-260 represent a cryptogram generation process to generate a cryptogram 108 for a particular transaction. While these operations are shown and described separately here (e.g., for a tokenization-only type request, for a cryptogram-only type request), it should be understood that these operations may be combined and/or initiated via a single request (e.g., for a tokenization+cryptogram request, such as shown and described for prep request 117 of FIG. 1). In some examples, cryptogram generation and validation may be used independently from tokenization (e.g., without tokenizing the PAN 102, prior to tokenization of the PAN 102).

Referring now to the tokenization process of operations 210-230, at operation 210 in the example, the merchant system 116 initiates a tokenization request with the ET service 140 (e.g., via the tokenization service 142). In the example, the tokenization request includes at least the PAN 102 of the payment card 113 of the cardholder 112 and may include other payment card information (e.g., expiry, security code) or cardholder information (e.g., cardholder name). At operation 212, the tokenization service 142 performs a PAN lookup in the mapping DB 146 (e.g., searching for a tokenization mapping that already includes the PAN). If an existing tokenization mapping is found for the particular PAN, and perhaps if that tokenization mapping allows the particular token to be used either at the requesting merchant or is not a merchant-specific token, then the tokenization service 142 skips to operation 230 and returns the identified token to the merchant system 116. In such scenarios, generation of a new token is not needed for this PAN 102 because an existing token 106 is already present and is usable by this requesting merchant.

In situations where no pre-existing token 106 is already stored in the mapping DB 146, the tokenization service 142 proceeds with the tokenization process. Prior to generating a new token for this PAN 102, the tokenization service 142 initiates a PAN validation request with the issuer 150 associated with this PAN 102 at operation 220. This PAN validation request may be similar to the validation request 152 shown in FIG. 1. The PAN validation request includes at least the PAN 102, thereby allowing the issuer 150 to validate whether or not they will allow the tokenization process to continue. For this example, it is presumed that the issuer 150 responds positively to the PAN validation with an issuer approval during operation 220, and the tokenization process can continue.

At operation 222, in the example, the tokenization service 142 generates a new token 106 for the PAN 102. At operation 224, the tokenization service 142 adds a tokenization mapping into the mapping DB 146. The tokenization mapping includes at least the original PAN 102 and the token 106 generated for that PAN 102, and may include other data such as, for example, information about the requesting merchant (e.g., merchant ID), information about the cardholder 112 or payment card 113, creation data associated with this tokenization (e.g., creation time), token use restrictions (e.g., merchant-specific, single-or multi-use, token expiration time or lifetime limits, transaction amount limits, or the like).

In the example, the tokenization service 142 returns the new token 106 to the merchant system 116 at operation 230. In some examples (e.g., if the tokenization request is a tokenization+cryptogram type request), the tokenization service 142 may proceed to generate a cryptogram 108 by requesting a cryptogram (e.g., similar to operation 240) with the cryptogram service 144.

Referring now to the cryptogram generation process of operations 240-260, at operation 240 in the example, the merchant system 116 requests a new cryptogram from the cryptogram service 144 for a particular transaction. This cryptogram request of operation 240 includes at least the token 106 and may include the merchant ID 104, the transaction amount 109, and any other data that is used in cryptogram verification, particularly any data that is bound to the cryptogram and used to authenticate the cryptogram during authorization. In example described in FIG. 1, the binding data includes the token 106, the merchant ID 104, and the transaction amount 109. In some examples, upon receipt of the request, the cryptogram service 144 validates the token at operation 250 by searching the mapping DB 146 for the token 106 to ensure that the token 106 is legitimate (e.g., has an existing, unexpired/valid tokenization mapping stored in the DB 146) and perhaps that the token 106 is allowed to use cryptograms 108 (e.g., enabled, within a jurisdiction or geography that supports cryptogram use, or the like). If the token 106 is not defined, in some examples, the cryptogram service 144 rejects the request, where in other examples, the cryptogram service 144 may automatically cause a new token to be generated for the request (e.g., if the request includes a PAN 102 rather than a token, the cryptogram service 144 sends a tokenization request to the tokenization service 142).

In the example, at operation 252, the cryptogram service 144 generates a new cryptogram 108 for this request. In some examples, the cryptogram 108 is generated as a fixed-length string of random numeric or alpha-numeric digits or characters (e.g., 32-byte, 64-byte, 128-byte string). In some examples, the cryptogram service 144 ensures that the newly generated cryptogram 108 is unique (e.g., not an already-used value for another cryptogram 108 already stored in the mapping DB 146). At operation 254, the cryptogram service 144 stores the newly generated cryptogram 108 in the mapping DB 146 (e.g., as a new record) along with values for each of the bound attributes. In this example, the bound attributes include the token 106, the merchant ID 104, and the transaction amount 109. At operation 260, the cryptogram service 144 returns the new cryptogram 108 to the merchant system 116.

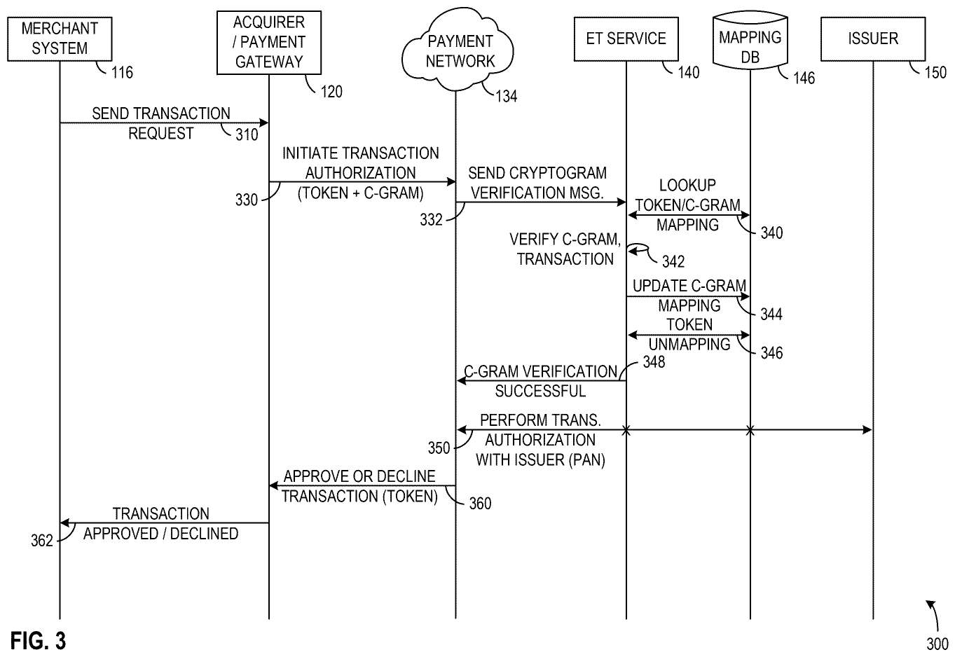

FIG. 3 is a sequence diagram 300 illustrating an example flow of operations performed by participants of an ET system (such as ET system 100 of FIG. 1) during the transaction authorization phase of a particular transaction. In examples, the operations shown in FIG. 3 may be similar to those shown and discussed above in relation to FIG. 1. Further, for this example, it is presumed that the merchant system 116 has already interacted with the ET service 140 to tokenize the PAN 102 of the cardholder 112 into token 106, as well as to generate a cryptogram 108 for this particular transaction (e.g., as shown and described in FIG. 1 and FIG. 2). In addition, it is also presumed that cardholder authentication has already occurred for this transaction. Since cardholder authentication does not directly involve the cryptogram 108, additional details of cardholder authentication are omitted here for brevity.

At operation 310, in the example, the merchant system 116 initiates a transaction request (e.g., transaction request 118 of FIG. 1) with the acquirer 120 or payment gateway for this particular transaction. The transaction request 118 includes at least the token 106, the cryptogram 108, and values for any bound attributes (e.g., the merchant ID 104 and the transaction amount 109), as well as other transaction data and cardholder data used to complete aspects of this transaction. Upon receipt, at operation 330, the acquirer 120 initiates an authorization request (e.g., auth request 132 of FIG. 1) for this transaction with the payment network 134. In the example, this authorization request 132 includes a token 106X, the cryptogram 108X, the merchant ID 104X, and the transaction amount 109X. Like in FIG. 1, the “X” suffix is added here, as these values may or may not be the same as their counterpart values in token 106, cryptogram 108, merchant ID 104, and transaction amount 109, and it is one of the additional security features of this ET system 100 to compare the values received in the authorization request 132 with the values recorded at the time the cryptogram 108 was generated (the “original values”).

At operation 332, the payment network 134 determines that this authorization request 132 involves tokenization and/or cryptograms, and thus the payment network 134 generates and transmits a cryptogram verification request message (e.g., cryptogram verification 136 of FIG. 1) to the ET service 140. In the example, the cryptogram verification 136 includes the token 106X, the cryptogram 108X, the merchant ID 104X, and the transaction amount 109X, and may include any of the other data included in the authorization request 132, such as an ID of the acquirer 120 or payment gateway.

In the example, and in response to the cryptogram verification 136, the ET service 140 (e.g., the cryptogram service 144) searches the mapping DB for a record that matches the cryptogram 108X at operation 340. If a cryptogram mapping is not found in the mapping DB 146, then the ET service 140 responds to the cryptogram verification 136 with a failure message (e.g., including failure code(s), or the like) and the payment network 134 skips to operation 360 and declines the transaction.

Presuming a cryptogram mapping is found for the cryptogram 108X (e.g., the cryptogram 108X from the cryptogram verification 136 matches the original cryptogram 108), the ET service 140 retrieves values for at least the bound attributes from the mapping. In this example, the ET service 140 retrieves the original token 106, merchant ID 104, and transaction amount 109.

At operation 342, the ET service 140 verifies the cryptogram 108X and associated attributes included in the authentication request 132. More specifically, in the example, the ET service 140 compares the original token 106 with the token 106X of the cryptogram verification 136. If the token 106X does not match the original token 106, then the ET service 140 responds to the cryptogram verification 136 with a failure message (e.g., a token mismatch code) and the payment network 134 skips to operation 360 and declines the transaction. If the merchant ID 104X does not match the original token 106, then the ET service 140 responds to the cryptogram verification 136 with a failure message (e.g., a merchant mismatch code) and the payment network 134 skips to operation 360 and declines the transaction. If the transaction amount 109X does not match the original transaction amount 109, then the ET service 140 responds to the cryptogram verification 136 with a failure message (e.g., a transaction amount mismatch code) and the payment network 134 skips to operation 360 and declines the transaction. In some examples, comparison of the transaction amounts 109X, 109 instead compares the transaction amount 109X with a transaction amount range generated based on the original transaction amount 109, and the comparison includes determining whether or not the transaction amount 109X falls within that range (e.g., failing when outside the range). In some examples, a more generic cryptogram verification failure code can be used in lieu of, or in addition to, a more failure specific code. In some examples, additional or different bound attributes may be verified at operation 342. In some examples, the ET service 140 checks a status of the cryptogram mapping to ensure that the cryptogram 108X is still available to be used (e.g., active, not expired, or the like) and similarly fails the cryptogram verification 136 if the status is inactive, expired, or such.

At operation 344, in some examples, the ET service 140 updates the cryptogram mapping based on receipt of the cryptogram 108x in the cryptogram verification 136. In examples, the update of operation 344 includes changing a status of the cryptogram mapping to a deactivated status (e.g., expired, inactive, previously used, or the like), thereby not allowing the cryptogram 108X to be used again in another transaction. In some examples, the update of operation 344 also includes storing verification data associated with this cryptogram verification 136, such as a verification timestamp (e.g., a datetime value indicating when the cryptogram verification 136 was received), a verification outcome status (e.g., successful, failed), and perhaps one or more failure codes generated during the verification (e.g., token mismatch, merchant ID mismatch, transaction amount exceeds maximum threshold, or the like).

Presuming the example cryptogram verification 136 is successful, the ET service 140 performs a token unmapping of the token 106X to the original PAN 102 at operation 346. More specifically, the ET service 140 searches the token mappings from the mappings DB 146 for the token 106X and retrieves the PAN 102 associated with that entry. If no token mapping entry is found for the token 106X, then the ET service 140 responds to the cryptogram verification 136 with a failure message (e.g., a token not found code) and the payment network 134 skips to operation 360 and declines the transaction.

At operation 348, in the example, the ET service 140 responds to the cryptogram verification 136 with a successful cryptogram verification message. In examples, this message also includes the original PAN 102 associated with the token 106X.

After receiving a successful cryptogram verification message, the payment network 134 performs a transaction authorization with an issuer associated with the PAN 102 at operation 350. In examples, this operation 350 includes transmitting an authorization request to the issuer 150. This authorization request excludes the cryptogram 108X, replaces the token 106X with the PAN 102, and may include any of the other data included in the authorization request 132. In response, the issuer 150 responds with an approval or decline message for this transaction. Accordingly, at operation 360, the ET service 140 responds to the acquirer 120 with either a transaction approval or transaction decline message. In examples, the response of operation 360 uses the token 106X and not the PAN 102 (e.g., to keep the PAN 102 secure). Likewise, the acquirer 120 responds to the merchant system 116 with either an approval or a decline for the transaction at operation 362.

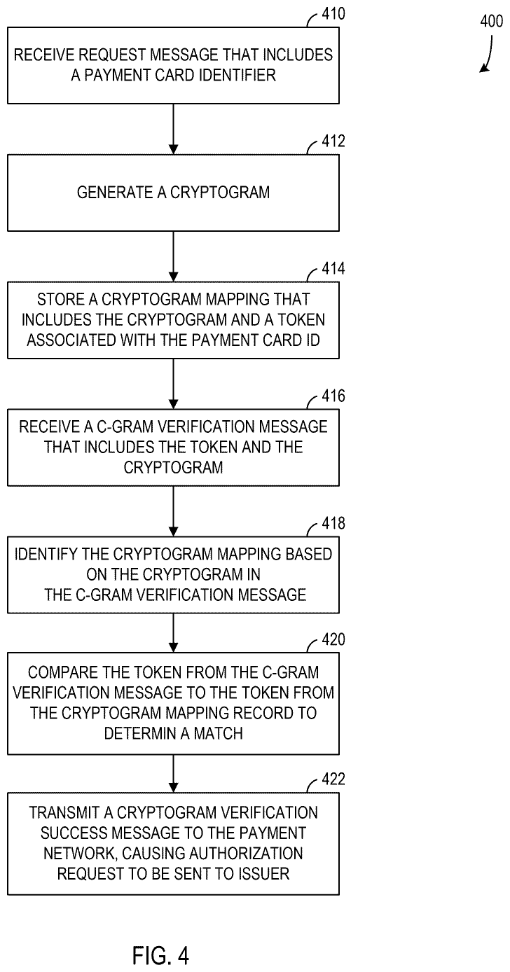

FIG. 4 is a flow chart of an example process 400 for securing payment card transactions with cryptograms. In examples, operations of the process 400 are performed by the ET service 140 in the ET system 100 of FIG. 1. At operation 410, in the example, the ET service 140 receives a first request message (e.g., preparation request 117) from a merchant device (e.g., merchant system 116), the first request including a payment card identifier (e.g., PAN 102, token 106) associated with a payment card (e.g., payment card 113). At operation 412, the ET service 140 generates a cryptogram (e.g., cryptogram 108), the cryptogram being a transaction key presentable to a payment network (e.g., payment network 134) during authorization of payment card transactions.

At operation 414, in the example, the ET service 140 stores a cryptogram mapping record (e.g., a record or entry in the mapping DB 146) that includes at least the cryptogram and a token (e.g., token 106) associated with the payment card identifier. At operation 416, the ET service 140 receives a cryptogram verification request message (e.g., cryptogram verification 136) from the payment network, the cryptogram verification request message being associated with an authorization request (e.g., authorization request 132) presented to the payment network, the cryptogram verification request message including the token and the cryptogram. At operation 418, the ET service 140 identifies the cryptogram mapping based on the cryptogram presented in the cryptogram verification request message.

At operation 420, the ET service 140 compares the token from the cryptogram verification request message (e.g., token 106X) to the token from the cryptogram mapping record (e.g., token 106) to determine a match. At operation 422, in response to the comparing, the ET service 140 transmits a cryptogram verification success message to the payment network, thereby causing the payment network to send the authorization request to an issuer.

In some examples, the first request message further includes a merchant identifier (ID) (e.g., merchant ID 104), storing the cryptogram mapping record further includes storing the cryptogram, the token, and the merchant ID in the cryptogram mapping record, and the comparing further includes comparing the merchant ID of the cryptogram verification request message (e.g., merchant ID 104X) to the merchant ID of the cryptogram mapping record (e.g., merchant ID 104) to determine the match.

In some examples, the first request message further includes a transaction amount (e.g., transaction amount 109), storing the cryptogram mapping record further includes storing the cryptogram, the token, and the transaction amount, and the comparing further includes comparing the transaction amount of the cryptogram verification request message (e.g., transaction amount 109X) to the transaction amount of the cryptogram mapping record (e.g., transaction amount 109) to determine the match. In some examples, the comparing further includes determining that the transaction amount appearing in the cryptogram verification request message is one of: (1) within a predefined range of the transaction amount appearing in the cryptogram mapping; (2) exactly matches the transaction amount appearing in the cryptogram mapping; and (3) does not exceed the transaction amount appearing in the cryptogram mapping.

In some examples, the ET service 140 updates the cryptogram mapping in response to the receiving of the cryptogram verification request message, the update including changing the cryptogram mapping record from an active status to an inactive status.

In some examples, the ET service 140 receives another cryptogram verification request message from the payment network, the other cryptogram verification request message including the cryptogram, determines that another use of the cryptogram is invalid based on the cryptogram mapping record being set to the inactive status, and responds to the cryptogram verification request message with a failure message, thereby causing the payment network to decline the transaction.

In some examples, the ET service 140 receives a second request message, the second request including the token, generates a second cryptogram, stores a second cryptogram mapping between the token and the second cryptogram, and successfully verifies a second cryptogram verification request message having the second cryptogram and the token based on the second cryptogram mapping.

### Exemplary Operating Environment

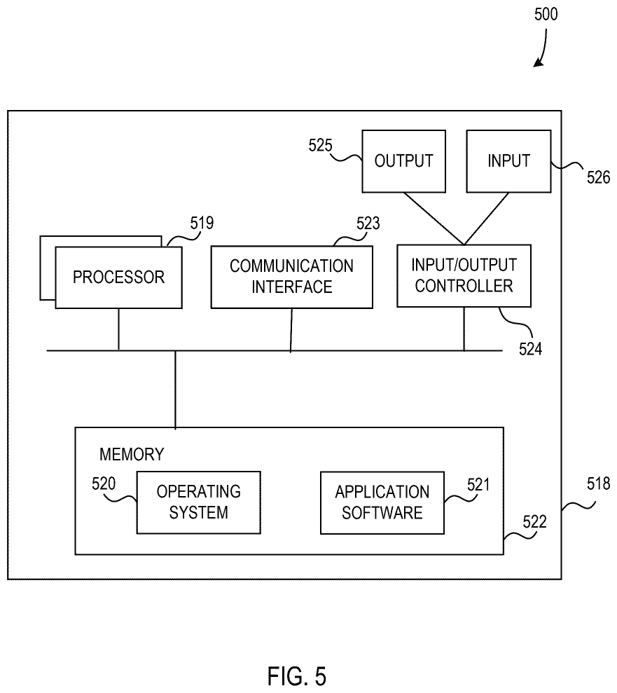

The present disclosure is operable with a computing apparatus according to an embodiment as a functional block diagram 500 in FIG. 5. In an example, components of a computing apparatus 518 are implemented as a part of an electronic device according to one or more embodiments described in this specification. The computing apparatus 518 is a computing device, such as, but not limited to, the merchant system 116 or the ET service 140 in FIG. 1.

The computing apparatus 518 comprises one or more processors 519 which can be microprocessors, controllers, or any other suitable type of processors for processing computer executable instructions to control the operation of the electronic device. Alternatively, or in addition, the processor 519 is any technology capable of executing logic or instructions, such as a hardcoded machine. In some examples, platform software comprising an operating system 520 or any other suitable platform software is provided on the apparatus 518 to enable application software 521 to be executed on the device. Examples of the disclosure may be implemented by software, hardware, and/or firmware.

In some examples, computer executable instructions are provided using any computer-readable medium or media accessible by the computing apparatus 518. Computer-readable media include, for example, computer storage media such as a memory 522 and communications media. Computer storage media, such as a memory 522, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium does not include a propagating signal. Propagated signals per se are not examples of computer storage media. Although the computer storage medium (the memory 522) is shown within the computing apparatus 518, it will be appreciated by a person skilled in the art, that, in some examples, the storage is distributed or located remotely and accessed via a network or other communication link (e.g., using a communication interface 523).

Further, in some examples, the computing apparatus 518 comprises an input/output controller 524 configured to output information to one or more output devices 525, for example a display or a speaker, which are separate from or integral to the electronic device. Additionally, or alternatively, the input/output controller 524 is configured to receive and process an input from one or more input devices 526, for example, a keyboard, a microphone, or a touchpad. In one example, the output device 525 also acts as the input device. An example of such a device is a touch sensitive display. The input/output controller 524 in other examples outputs data to devices other than the output device, e.g., a locally connected printing device. In some examples, a user provides input to the input device(s) 526 and/or receives output from the output device(s) 525.

The functionality described herein can be performed, at least in part, by one or more hardware logic components. The computing apparatus 518 is configured by the program code when executed by the processor 519 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

### ADDITIONAL EXAMPLES

In some examples, an enhanced tokenization system is provided. The enhanced tokenization system comprises: at least one processor; and at least one memory comprising computer-readable instructions, the at least one processor, the at least one memory and the computer-readable instructions configured to cause the at least one processor to: receive a first request from a merchant device, the first request including a primary account number (PAN); generate a token, the token being usable as a substitute for the PAN in a payment network; generate a cryptogram, the cryptogram being a single-use transaction key for a transaction on the payment network; store a cryptogram mapping between the token and the cryptogram; transmit the token and the cryptogram to the merchant device in response to the first request; receive a cryptogram verification request message from the payment network, the cryptogram verification request message being associated with an authorization request of the payment network, the cryptogram verification request message including the token and the cryptogram; determine that the cryptogram and the token of the cryptogram verification request message are valid based on the token and the cryptogram appearing in the cryptogram mapping; and respond to the cryptogram verification request message with a success indicator, thereby causing the payment network to send the authorization request to an issuer.

In some examples, a computer-implemented method is provided. The computer-implemented method comprises: receiving a first request message from a merchant device, the first request including a payment card identifier associated with a payment card; generating a cryptogram, the cryptogram being a transaction key presentable to a payment network during authorization of payment card transactions; storing a cryptogram mapping record that includes at least the cryptogram and a token associated with the payment card identifier; receiving a cryptogram verification request message from the payment network, the cryptogram verification request message being associated with an authorization request presented to the payment network, the cryptogram verification request message including the token and the cryptogram; identifying the cryptogram mapping based on the cryptogram presented in the cryptogram verification request message; comparing the token from the cryptogram verification request message to the token from the cryptogram mapping record to determine a match; and in response to the comparing, transmitting a cryptogram verification success message to the payment network, thereby causing the payment network to send the authorization request to an issuer.

In some examples, a computer storage medium having computer-executable instructions is provided. Upon execution by a processor of a computer, the computer-executable instructions cause the processor to at least: receive, from a merchant computing device, a first request message that includes a primary account number (PAN) of a payment card and an original transaction amount; generate an original token, the original token being usable as a substitute for the PAN in a payment network; generate an original cryptogram; store a cryptogram mapping between the original token, the original cryptogram, and the original transaction amount; transmit the original token and the original cryptogram to the merchant computing device in response to the first request message; receive a cryptogram verification request message from the payment network, the cryptogram verification request message being associated with a transaction authorization request, the cryptogram verification request message including a presented token, a presented cryptogram, and a presented transaction amount; determine that the original cryptogram matches the presented cryptogram, and the original token matches the presented token based on the cryptogram mapping; and respond to the cryptogram verification request message with a success indicator, thereby causing the payment network to send the authorization request to an issuing bank for authorization.

Alternatively, or in addition to the other examples described herein, examples include any combination of the following:
receive a first request from a merchant device, the first request including a primary account number (PAN);
generate a token;
a token being usable as a substitute for the PAN in a payment network;
a token being a plurality of randomized alphabetical, numeric, or alpha-numeric characters;
a token being unique amongst a plurality of tokens;
generate a cryptogram;
a cryptogram being a single-use transaction key for a transaction on the payment network;
a cryptogram being a plurality of randomized alphabetical, numeric, or alpha-numeric characters;
a cryptogram being unique amongst a plurality of cryptograms;
store a cryptogram mapping between the token and the cryptogram;
a cryptogram mapping being a record in a database storing a cryptogram and one or more additional bound attributes;
a bound attribute being an attribute that is compared to a corollary attribute from an authentication request and appearing with the cryptogram in the authentication request;
transmit the token and the cryptogram to the merchant device in response to the first request;
receive a cryptogram verification request message from the payment network;
the cryptogram verification request message being associated with an authorization request of the payment network;
the cryptogram verification request message including the token and the cryptogram;
determine that the cryptogram and the token of the cryptogram verification request message are valid based on the token and the cryptogram appearing in the cryptogram mapping;
respond to the cryptogram verification request message with a success indicator, thereby causing the payment network to send the authorization request to an issuer;
the first request further includes a merchant identifier (ID);
storing the cryptogram mapping further includes storing the cryptogram, the token, and the merchant ID;
the determining further includes determining that the merchant ID is valid based on the cryptogram mapping;
the first request further includes a transaction amount;
storing the cryptogram mapping further includes storing the cryptogram, the token, and the transaction amount;
the determining further includes determining that the transaction amount is valid based on the cryptogram mapping;
determining that the transaction amount is valid based on the cryptogram mapping further includes determining that the transaction amount appearing in the cryptogram verification request message is one of: (1) within a predefined range of the transaction amount appearing in the cryptogram mapping; (2) exactly matches the transaction amount appearing in the cryptogram mapping; and (3) does not exceed the transaction amount appearing in the cryptogram mapping;
determining that the transaction amount is valid includes determining that the transaction amount appears within a range of the transaction amount appearing in the cryptogram mapping;
determining that the transaction amount is valid includes determining that the transaction amount exactly matches the transaction amount appearing in the cryptogram mapping;
determining that the transaction amount is valid includes determining that the transaction amount does not exceed the transaction amount appearing in the cryptogram mapping;
update the cryptogram mapping in response to the receiving of the cryptogram verification request message, the update including changing an active status of the cryptogram from active to inactive;
receive another cryptogram verification request message from the payment network, the other cryptogram verification request message including the cryptogram;
determine that usage of the cryptogram in this other cryptogram verification request message is invalid based on the active status of the cryptogram being set to inactive;
respond to the cryptogram verification request message with a failure indicator, thereby causing the payment network to decline a transaction associated with the other cryptogram verification request message;
receive a second request, the second request includes the token;
generate a second cryptogram;
store a second cryptogram mapping between the token and the second cryptogram;
transmit the second cryptogram to the merchant device in response to the second request;
receiving a first request message from a merchant device, the first request including a payment card identifier associated with a payment card;
generating a cryptogram, the cryptogram being a transaction key presentable to a payment network during authorization of payment card transactions;
storing a cryptogram mapping record that includes at least the cryptogram and a token associated with the payment card identifier;
receiving a cryptogram verification request message from the payment network, the cryptogram verification request message being associated with an authorization request presented to the payment network, the cryptogram verification request message including the token and the cryptogram;
identifying the cryptogram mapping based on the cryptogram presented in the cryptogram verification request message;
comparing the token from the cryptogram verification request message to the token from the cryptogram mapping record to determine a match;
in response to the comparing, transmitting a cryptogram verification success message to the payment network, thereby causing the payment network to send the authorization request to an issuer;
the first request message further includes a merchant identifier (ID);
storing the cryptogram mapping record further includes storing the cryptogram, the token, and the merchant ID in the cryptogram mapping record;
the comparing further includes comparing the merchant ID of the cryptogram verification request message to the merchant ID of the cryptogram mapping record to determine the match;
the first request message further includes a transaction amount;
storing the cryptogram mapping record further includes storing the cryptogram, the token, and the transaction amount;
the comparing further includes comparing the transaction amount of the cryptogram verification request message to the transaction amount of the cryptogram mapping record to determine the match;
the comparing further includes determining that the transaction amount appearing in the cryptogram verification request message is one of: (1) within a predefined range of the transaction amount appearing in the cryptogram mapping; (2) exactly matches the transaction amount appearing in the cryptogram mapping; and (3) does not exceed the transaction amount appearing in the cryptogram mapping;
updating the cryptogram mapping in response to the receiving of the cryptogram verification request message, the update including changing the cryptogram mapping record from an active status to an inactive status;
receiving another cryptogram verification request message from the payment network, the other cryptogram verification request message including the cryptogram;
determining that another use of the cryptogram is invalid based on the cryptogram mapping record being set to the inactive status;
responding to the cryptogram verification request message with a failure message, thereby causing the payment network to decline the transaction;
receiving a second request message, the second request including the token;
generating a second cryptogram;
storing a second cryptogram mapping between the token and the second cryptogram;
successfully verifying a second cryptogram verification request message having the second cryptogram and the token based on the second cryptogram mapping;
receive, from a merchant computing device, a first request message that includes a primary account number (PAN) of a payment card and an original transaction amount;
generate an original token, the original token being usable as a substitute for the PAN in a payment network;
generate an original cryptogram;
store a cryptogram mapping between the original token, the original cryptogram, and the original transaction amount;
transmit the original token and the original cryptogram to the merchant computing device in response to the first request message;
receive a cryptogram verification request message from the payment network, the cryptogram verification request message being associated with a transaction authorization request, the cryptogram verification request message including a presented token, a presented cryptogram, and a presented transaction amount;
determine that the original cryptogram matches the presented cryptogram, and the original token matches the presented token based on the cryptogram mapping;
respond to the cryptogram verification request message with a success indicator, thereby causing the payment network to send the authorization request to an issuing bank for authorization;
the first request message further includes an original merchant identifier (ID);
storing the cryptogram mapping further includes storing the original cryptogram, the original token, the original transaction amount, and the original merchant ID;
the cryptogram verification request message further includes a presented merchant ID, and wherein the determining further determining that the original merchant ID matches the presented merchant ID;
the determining further includes one of: (1) determining that the presented transaction amount is within a predefined range of the original transaction amount; (2) determining that the original transaction amount exactly matches the presented transaction amount; and (3) determining that the presented transaction amount does not exceed the original transaction amount;
update the cryptogram mapping in response to the receiving of the cryptogram verification request message;
the update including changing a status of the cryptogram mapping from an active status to an inactive status, thereby causing future attempts to use the original cryptogram to fail;
receive another cryptogram verification request message from the payment network, the other cryptogram verification request message including the original cryptogram;
determine that another usage of the original cryptogram is invalid based on the active status of the cryptogram being set to inactive;
respond to the other cryptogram verification request message with a failure indicator, thereby causing the payment network to decline an associated transaction;
receive a second request, the second request includes the token;
generate a second cryptogram;
store a second cryptogram mapping between the token and the second cryptogram;
transmit the second cryptogram to the merchant computing device in response to the second request.

Any range or device value given herein may be extended or altered without losing the effect sought, as will be apparent to the skilled person.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent can take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute exemplary means for receiving a first request message from a merchant device, the first request including a payment card identifier associated with a payment card; means for generating a cryptogram, the cryptogram being a transaction key presentable to a payment network during authorization of payment card transactions; means for storing a cryptogram mapping record that includes at least the cryptogram and a token associated with the payment card identifier; means for receiving a cryptogram verification request message from the payment network, the cryptogram verification request message being associated with an authorization request presented to the payment network, the cryptogram verification request message including the token and the cryptogram; means for identifying the cryptogram mapping based on the cryptogram presented in the cryptogram verification request message; means for comparing the token from the cryptogram verification request message to the token from the cryptogram mapping record to determine a match; and in response to the comparing, means for transmitting a cryptogram verification success message to the payment network, thereby causing the payment network to send the authorization request to an issuer.

At least a portion of the functionality of the various elements in FIG. 1 to FIG. 5 can be performed by other elements in FIG. 1 to FIG. 5, or an entity (e.g., processor, web service, server, application program, computing device, etc.) not shown in FIG. 1 to FIG. 5.

In some examples, the operations illustrated in FIG. 1 and FIG. 4 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Within the scope of this application, it is expressly intended that the various aspects, embodiments, examples, and alternatives set out in the preceding paragraphs, in the claims and/or in the description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim, accordingly, including the right to amend any originally filed claim to depend from and/or incorporate any feature of any other claim although not originally claimed in that manner.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A tokenization system comprising:
at least one processor; and
at least one memory comprising computer-readable instructions, the at least one processor, the at least one memory and the computer-readable instructions configured to cause the at least one processor to:
receive a first request from a merchant device, the first request including a primary account number (PAN);
generate a token, the token being usable as a substitute for the PAN in a payment network;
generate a cryptogram, the cryptogram being a single-use transaction key for a transaction on the payment network;
store a cryptogram mapping between the token and the cryptogram;
transmit the token and the cryptogram to the merchant device in response to the first request;
receive a cryptogram verification request message from the payment network, the cryptogram verification request message being associated with an authorization request of the payment network, the cryptogram verification request message including the token and the cryptogram;
determine that the cryptogram and the token of the cryptogram verification request message are valid based on the token and the cryptogram appearing in the cryptogram mapping; and
respond to the cryptogram verification request message with a success indicator, thereby causing the payment network to send the authorization request to an issuer.

2. The tokenization system of claim 1, wherein the first request further includes a merchant identifier (ID), wherein storing the cryptogram mapping further includes storing the cryptogram, the token, and the merchant ID, and wherein the determining further includes determining that the merchant ID is valid based on the cryptogram mapping.

3. The tokenization system of claim 1, wherein the first request further includes a transaction amount, wherein storing the cryptogram mapping further includes storing the cryptogram, the token, and the transaction amount, and wherein the determining further includes determining that the transaction amount is valid based on the cryptogram mapping.

4. The tokenization system of claim 3, wherein determining that the transaction amount is valid based on the cryptogram mapping further includes determining that the transaction amount appearing in the cryptogram verification request message is one of: (1) within a predefined range of the transaction amount appearing in the cryptogram mapping; (2) exactly matches the transaction amount appearing in the cryptogram mapping; and (3) does not exceed the transaction amount appearing in the cryptogram mapping.

5. The tokenization system of claim 1, wherein the computer-readable instructions are further configured to cause the at least one processor to:
update the cryptogram mapping in response to the receiving of the cryptogram verification request message, the update including changing an active status of the cryptogram from active to inactive.

6. The tokenization system of claim 5, wherein the computer-readable instructions are further configured to cause the at least one processor to:
receive another cryptogram verification request message from the payment network, the other cryptogram verification request message including the cryptogram;
determine that usage of the cryptogram in this other cryptogram verification request message is invalid based on the active status of the cryptogram being set to inactive; and
respond to the cryptogram verification request message with a failure indicator, thereby causing the payment network to decline a transaction associated with the other cryptogram verification request message.

7. The tokenization system of claim 1, wherein the computer-readable instructions are further configured to cause the at least one processor to:
receive a second request, the second request including the token;
generate a second cryptogram;
store a second cryptogram mapping between the token and the second cryptogram; and
transmit the second cryptogram to the merchant device in response to the second request.

8. A computer-implemented method comprising:
receiving a first request message from a merchant device, the first request message including a payment card identifier associated with a payment card;
generating a cryptogram, the cryptogram being a transaction key presentable to a payment network during authorization of payment card transactions;
storing a cryptogram mapping record that includes at least the cryptogram and a token associated with the payment card identifier;
receiving a cryptogram verification request message from the payment network, the cryptogram verification request message being associated with an authorization request presented to the payment network, the cryptogram verification request message including the token and the cryptogram;
identifying the cryptogram mapping record based on the cryptogram presented in the cryptogram verification request message;
comparing the token from the cryptogram verification request message to the token from the cryptogram mapping record to determine a match; and
in response to the comparing, transmitting a cryptogram verification success message to the payment network, thereby causing the payment network to send the authorization request to an issuer.

9. The computer-implemented method of claim 8, wherein the first request message further includes a merchant identifier (ID), wherein storing the cryptogram mapping record further includes storing the cryptogram, the token, and the merchant ID in the cryptogram mapping record, and wherein the comparing further includes comparing the merchant ID of the cryptogram verification request message to the merchant ID of the cryptogram mapping record to determine the match.

10. The computer-implemented method of claim 8, wherein the first request message further includes a transaction amount, wherein storing the cryptogram mapping record further includes storing the cryptogram, the token, and the transaction amount, and wherein the comparing further includes comparing the transaction amount of the cryptogram verification request message to the transaction amount of the cryptogram mapping record to determine the match.

11. The computer-implemented method of claim 10, wherein the comparing further includes determining that the transaction amount appearing in the cryptogram verification request message is one of: (1) within a predefined range of the transaction amount appearing in the cryptogram mapping record; (2) exactly matches the transaction amount appearing in the cryptogram mapping record; and (3) does not exceed the transaction amount appearing in the cryptogram mapping record.

12. The computer-implemented method of claim 8, further comprising updating the cryptogram mapping record in response to the receiving of the cryptogram verification request message, the update including changing the cryptogram mapping record from an active status to an inactive status.

13. The computer-implemented method of claim 12, further comprising:
receiving another cryptogram verification request message from the payment network, the other cryptogram verification request message including the cryptogram;
determining that another use of the cryptogram is invalid based on the cryptogram mapping record being set to the inactive status; and
responding to the cryptogram verification request message with a failure message, thereby causing the payment network to decline a transaction associated with the other cryptogram verification request message.

14. The computer-implemented method of claim 8, further comprising:
receiving a second request message, the second request message including the token;
generating a second cryptogram;
storing a second cryptogram mapping between the token and the second cryptogram; and
successfully verifying a second cryptogram verification request message having the second cryptogram and the token based on the second cryptogram mapping.

15. A computer storage medium having computer-executable instructions that, upon execution by a processor of a computer, cause the processor to at least:
receive, from a merchant computing device, a first request message that includes a primary account number (PAN) of a payment card and an original transaction amount;
generate an original token, the original token being usable as a substitute for the PAN in a payment network;
generate an original cryptogram;
store a cryptogram mapping between the original token, the original cryptogram, and the original transaction amount;
transmit the original token and the original cryptogram to the merchant computing device in response to the first request message;
receive a cryptogram verification request message from the payment network, the cryptogram verification request message being associated with a transaction authorization request, the cryptogram verification request message including a presented token, a presented cryptogram, and a presented transaction amount;
determine that the original cryptogram matches the presented cryptogram, and the original token matches the presented token based on the cryptogram mapping; and
respond to the cryptogram verification request message with a success indicator, thereby causing the payment network to send the authorization request to an issuing bank for authorization.

16. The computer storage medium of claim 15, wherein the first request message further includes an original merchant identifier (ID), wherein storing the cryptogram mapping further includes storing the original cryptogram, the original token, the original transaction amount, and the original merchant ID, wherein the cryptogram verification request message further includes a presented merchant ID, and wherein the determining further includes determining that the original merchant ID matches the presented merchant ID.

17. The computer storage medium of claim 15, wherein the determining further includes one of: (1) determining that the presented transaction amount is within a predefined range of the original transaction amount; (2) determining that the original transaction amount exactly matches the presented transaction amount; and (3) determining that the presented transaction amount does not exceed the original transaction amount.

18. The computer storage medium of claim 15, wherein the computer-executable instructions are further configured to cause the processor to:
update the cryptogram mapping in response to the receiving of the cryptogram verification request message, the update including changing a status of the cryptogram mapping from an active status to an inactive status, thereby causing future attempts to use the original cryptogram to fail.

19. The computer storage medium of claim 18, wherein the computer-executable instructions are further configured to cause the processor to:
receive another cryptogram verification request message from the payment network, the other cryptogram verification request message including the original cryptogram;
determine that another usage of the original cryptogram is invalid based on the active status of the cryptogram being set to inactive; and
respond to the other cryptogram verification request message with a failure indicator, thereby causing the payment network to decline an associated transaction.

20. The computer storage medium of claim 15, wherein the computer-executable instructions are further configured to cause the processor to:
receive a second request, the second request including the token;
generate a second cryptogram;
store a second cryptogram mapping between the token and the second cryptogram; and
transmit the second cryptogram to the merchant computing device in response to the second request.
